(19) United States
(12) Patent Application Publication
(10) Pub. No.: US 2023/0194680 A1
(43) Pub. Date: Jun. 22, 2023

(54) Method for Estimating the Time of Flight Between a First Equipment Item and a Second Equipment Item.

(71) Applicant: ORANGE, Issy-les-Moulineaux (FR)

(72) Inventors: Philippe Surbayrole, Chatillon Cedex (FR); Apostolos Kountouris, Chatillon Cedex (FR)

(21) Appl. No.: 18/066,606

(22) Filed: Dec. 15, 2022

(30) Foreign Application Priority Data
Dec. 16, 2021 (FR) 2113688

(51) Int. Cl. G01S 7/4865

(52) U.S. Cl. CPC G01S 7/4865

(57) ABSTRACT

A method for estimating the time of flight between a first equipment item and a second equipment item includes the following steps carried out by the first equipment item: reception from the second equipment item of a transmission information item representing a time interval between the instant of reception of a message from the first equipment item and the instant of transmission by the second equipment item of a message including the transmission information item; and estimation of the time of flight between the first equipment item and the second equipment item by using the transmission information item. The time of flight can be used to determine the distance between two equipment items, for synchronizing two equipment items, or for detecting a movement of an equipment item.

### FIELD OF THE DISCLOSURE

The present invention relates to a method for estimating the time of flight between a first equipment item and a second equipment item. It furthermore relates to a device for estimating the time of flight between two equipment items, which carries out such an estimation method.

The time of flight between the first equipment item and the second equipment item corresponds to the propagation time of a radiofrequency signal between the equipment items.

The invention applies in particular to connected objects for which estimating the propagation time of the radiofrequency signals between objects (or time of flight between objects) may be useful or even prove necessary. For example, the functioning of certain applications of the objects may be conditioned by the distance between the objects. In this context, the distance between two objects may be estimated from the time of flight between the objects.

### BACKGROUND OF THE DISCLOSURE

The use of connected or communicating objects is continuing to grow. It is nowadays common to find environments (for example buildings, factories, towns, etc.) in which very many objects connected to a communication network are installed and are used in numerous applications. Sometimes, the interaction between two objects is conditioned by the distance existing between these two objects. For example, a transaction command is sent by a terminal of a user to an electronic payment terminal only when these two terminals are close to one another. According to another example, a pay station located for example on a turnpike or in a public transport vehicle may be configured in order to debit a sum from a user’s account when a terminal of the user is detected in proximity to the station.

There are thus many applications in which it is necessary to determine the distance between objects.

One technique for estimating the distance between two objects consists in estimating the propagation time (or time of flight) of a radiofrequency signal (or radio signal) between the two objects.

The propagation time of a radio signal, or time of flight, between two objects may be estimated according to different techniques. According to one known technique, the objects include dedicated modules configured in order to estimate the time of flight between objects. In particular, a first object includes a module configured in order to transmit a signal to a second object, and this second object includes a module configured in order to return this signal to the first object. Knowing the transmission and reception times of the signal, the first object can estimate the propagation time of the radio signal between itself and the second object. Techniques of this type are known as round-trip time (RTT) calculation techniques. The applications installed on the first object may, if necessary, use the estimated time of flight between the two objects.

The accuracy of the time of flight estimated by these techniques may be more or less optimal depending on the context in which the objects are to be found.

Techniques for estimating the time of flight between two objects, which make it possible to estimate the time of flight accurately, are known. However, since these techniques are very expensive to carry out, these techniques cannot be employed by connected objects used in any context, for example by connected objects used in the daily life of the users. The reason is that this type of connected object is widely deployed while often being limited in terms of resources.

### SUMMARY

The invention provides a method for estimating the time of flight between two objects, which allows optimal estimation of the time of flight and can be used by any type of object, in particular by objects which do not have suitable resources for the use of complex and expensive techniques for estimating the time of flight.

For this purpose, according to a first aspect, the invention relates to a method for estimating the time of flight between a first equipment item and a second equipment item, including the following steps carried out by the first equipment item:
reception from the second equipment item of a transmission information item representing a time interval between the instant of reception of a message from said first equipment item and the instant of transmission by said second equipment item of a message including said transmission information item, and
estimation of the time of flight between the first equipment item and the second equipment item by using the transmission information item.

Thus, knowing the time interval which has elapsed between the reception of a message that it has sent and the transmission by the second equipment item of the message received from the second equipment item, the first equipment item can concisely estimate the time of flight between the first equipment item and the second equipment item, that is to say the propagation time of a radiofrequency signal between the first equipment item and the second equipment item, the radiofrequency signal carrying a message. This is because, knowing the time which the second equipment item has taken to transmit the message including the transmission information item since the reception of the message from the first equipment item, the first equipment item has knowledge of the time of flight between the objects, or in other words the real propagation time of the signals respectively carrying the messages exchanged between the equipment items.

The estimated time of flight between two equipment items may be used for different applications. For example, the distance between two equipment items may be estimated from the time of flight between the two equipment items. According to another exemplary application, the estimated time of flight may be used in order to synchronize the equipment items.

It will be noted that the estimation of the time of flight is a collaborative process between the two equipment items. The participation of the second equipment item in the estimation of the time of flight by the first equipment item makes it possible to estimate the time of flight between the equipment items more accurately. Furthermore, it makes it possible to avoid adding complex modules dedicated to the estimation of the time of flight between the equipment items, while estimating the time of flight between the equipment items optimally.

The first and second messages may be messages exchanged between the equipment items at the application level. In particular, the first and second messages may be messages exchanged between two application programming interfaces (API) installed respectively in the first equipment item and the second equipment item. The application programming interfaces loaded respectively in the first equipment item and in the second equipment item allow communication between two applications installed respectively in these equipment items in order to carry out operations.

According to one characteristic, the method furthermore includes transmission of said estimated time of flight.

The transmission of the estimated time of flight may be intended to be received by the second equipment item or broadcast. Independently of the transmission method used by the first equipment item, the second equipment item is aware of the time of flight between itself and the first equipment item. In the event that this second equipment item does not have the necessary resources (for example not having the necessary battery level) in order to calculate the time of flight, this collaborative process allows the second equipment item to know the estimated time of flight even though it is not at the origin of the estimation.

Thus, knowing this time of flight, the second equipment item may for example estimate the distance separating it from the first equipment item.

According to one characteristic, the estimation method furthermore includes transmission of a reception information item representative of an instant starting from which said first equipment item is configured in order to receive messages, the second equipment item taking this reception information item into account in order to determine the instant of transmission of the message including said transmission information item.

The second equipment item takes this reception information item into account in order to determine the instant of transmission of the message including said transmission information item. It will be noted that the first equipment item transmits a first message indicating the instant starting from which it will be “listening” in order to receive messages, in particular the message including the transmission information item. Receiving this first message from the first equipment item, the second equipment item is aware of this listening instant and transmits the transmission information item to the first equipment item.

Since the second equipment item is aware of the instant starting from which the first equipment item will be “listening” in order to receive messages, the estimation of the time of flight between the equipment items is carried out efficiently. This is because, by transmitting the message while taking into account the instant at which the first equipment item will be ready to listen for messages, the second equipment item avoids the first equipment item receiving messages when it is not listening for messages. Furthermore, the second equipment item transmits the message without waiting longer than is necessary. By virtue of these arrangements, the energy consumption of the electronic equipment items is optimal.

According to one characteristic, the estimation method furthermore includes transmission of a transmission information item representing a time interval between the instant of reception of a message received from the second equipment item and the instant of transmission of a message including said transmission information item.

By sending this information item, the first equipment item allows the second equipment item in turn to estimate the time of flight between the first equipment item and the second equipment item. It may then check whether this time of flight is similar to the time of flight estimated by the first equipment item, and may optionally take an average between the two.

According to one embodiment, the transmission information item of the first equipment item and the time of flight estimated by the first equipment item are transmitted by the first equipment item in the same message. According to another embodiment, the transmission information item of the first equipment item and the time of flight estimated by the first equipment item are transmitted by the first equipment item in different messages.

According to one characteristic, the estimation method furthermore includes reception of the time of flight between the first equipment item and the second equipment item, estimated by the second equipment item.

In the aforementioned collaborative process, since the second equipment item has itself estimated the time of flight between the first equipment item and the second equipment item, it may send this to the first equipment item. Sometimes, if it does not have means for carrying out this estimation, the first equipment item profits from the estimation carried out by the second equipment item. Sometimes, if it has itself estimated the time of flight between the first and the second equipment items, the first equipment item may for example compare the time of flight received from the second equipment item and the time of flight estimated by itself, in order to check whether the time of flight which it has obtained is reliable, for example by comparing the difference of the two estimated times of flight with a threshold.

According to one characteristic, the estimation method furthermore includes determination of the average of the previously estimated time of flight and the estimated time of flight received from the second equipment item, the average determined being the time of flight between the first and second equipment items.

According to one characteristic, the steps of the proposed method are carried out by at least one application programming interface (API), these application programming interfaces respectively being loaded in the first and second equipment items.

The characteristics of the estimation method presented below may be taken separately or in combination with one another.

According to a second aspect, the present invention relates to a device for estimating the time of flight between a first equipment item and a second equipment item, the estimation device comprising:
a reception module configured in order to receive from the second equipment item a transmission information item representing a time interval between the instant of reception of a message from said first equipment item and the instant of transmission by said second equipment item of a message including said transmission information item, and
an estimation module configured in order to estimate the time of flight between the first equipment item and the second equipment item by using the transmission information item.

According to one characteristic, the estimation device furthermore includes a transmission module configured in order to transmit the estimated time of flight.

According to one characteristic, the transmission module is furthermore configured in order to transmit a reception information item representative of an instant starting from which said first equipment item is configured in order to receive messages, the second equipment item taking this reception information item into account in order to determine the instant of transmission of the message including said transmission information item.

According to one characteristic, the transmission module is furthermore configured in order to transmit a transmission information item representing a time interval between the instant of reception of a message received from the second equipment item and the instant of transmission of a message including said transmission information item.

The transmission device is thus configured in order to determine the time interval between the instant of reception of a message received from the second equipment item and the instant of transmission of a message including said transmission information item.

According to one characteristic, the estimation device furthermore includes a reception module configured in order to receive the time of flight between the first equipment item and the second equipment item, estimated by the second equipment item.

According to one characteristic, the estimation device furthermore includes a determination module configured in order to determine the average of the time of flight previously estimated and the estimated time of flight received from the second equipment item, the average determined being the time of flight.

According to a third aspect, the present invention relates to an equipment item including an estimation device according to the invention, which carries out the estimation method according to the invention.

The equipment item includes an application programming interface, or API, configured in order to carry out the steps of the estimation method.

According to a fourth aspect, the present invention relates to a system including a first equipment item and a second equipment item, at least one of said equipment items including an estimation device according to the invention, which carries out the estimation method according to the invention.

According to a fifth aspect, the present invention relates to a program for a device, including program code instructions intended to control the execution of the steps of the estimation method according to the invention.

According to a sixth aspect, the present invention relates to an information medium readable by a processor in a device, on which the computer program according to the invention is stored.

According to a seventh aspect, the present invention relates to the use of the estimation method according to the invention in order to determine the distance between the first equipment item and the second equipment item, or in order to synchronize the first equipment item and the second equipment item.

The time of flight estimated by the proposed estimation method may be used in other applications.

The estimation device, the equipment item, the system, the program, the information medium and the use have characteristics and advantages similar to those described above in connection with the estimation method.

Other features and advantages of the invention will become more apparent in the following description.

### BRIEF DESCRIPTION OF THE DRAWINGS

In the appended drawings, which are given by way of nonlimiting examples:

FIG. 1 represents equipment items able to carry out the invention, and

FIG. 2a illustrates steps of the estimation method according to one embodiment, which is carried out by one equipment item;

FIG. 2b illustrates steps of the estimation method according to one embodiment, which is carried out by two equipment items;

FIG. 3 illustrates examples of messages which may be exchanged between the equipment items;

FIG. 4a illustrates a hardware architecture making it possible to carry out the estimation method according to the invention; and

FIG. 4b is a functional representation of an estimation device according to one embodiment of the invention.

The invention applies in particular to any connected or communicating object, that is to say to any object configured in order to communicate (transmit or receive data) with other equipment items.

### DETAILED DESCRIPTION OF ILLUSTRATIVE EMBODIMENTS

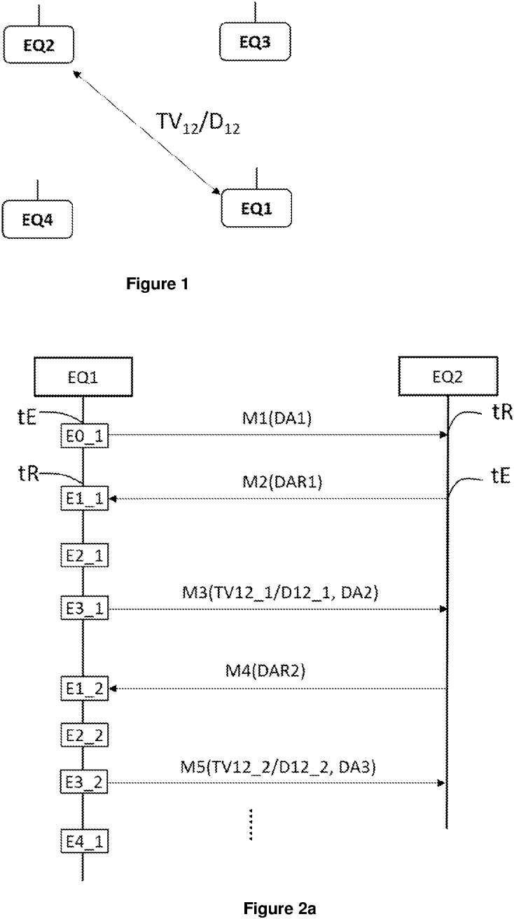

FIG. 1 represents a system including a plurality of equipment items EQ1, EQ2, EQ3, EQ4. These equipment items may be objects capable of communicating with other objects, that is to say of transmitting messages to other objects and of receiving messages from other objects. The objects may be connected to a communication network (not illustrated), for example a network of the LAN type (Local Area Network), such as a residential network or a business network, or an extended communication network 20 or a network of the WAN type (Wide Area Network), such as the Internet.

The equipment items EQ1-EQ4 may communicate with one another at least by means of wireless communications, for example according to a protocol such as Wi-Fi (Wireless Fidelity, registered trademark), Bluetooth (registered trademark), Wi-Fi, Wi-Fi Direct, LTE (Long Term Evolution), etc. Thus, they are adapted to transmit and receive messages in the form of radiofrequency signals. The equipment items EQ1-EQ4 may be configured in order to transmit messages to be received by one equipment item (transmission of the “unicast” type) and/or to be received by a plurality of equipment items (transmissions of the “broadcast” and “multicast” type).

The connected equipment items or objects EQ1-EQ4 may be of various types, and may be used for numerous applications and in numerous contexts. Examples of connected objects may be a mobile telephone terminal, a portable computer, a tablet, a gateway, a printer, an audio system, a television decoder, a television set, a games console, a household electrical appliance, a sensor, a camera, a wristwatch, eyeglasses, a payment terminal or station, etc.

In the rest of this document, the term equipment item, object, connected object or equipment item will be used interchangeably.

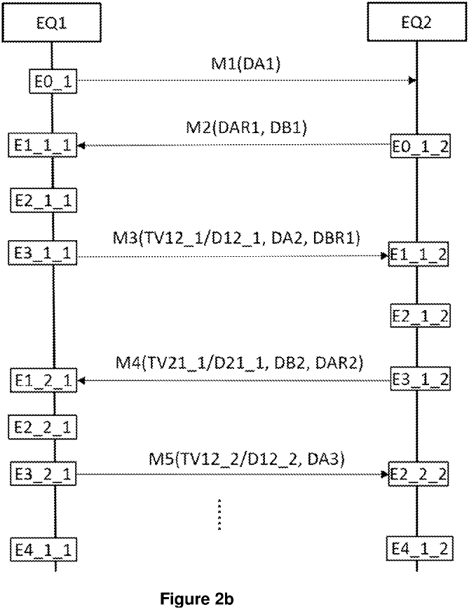

An equipment item EQ1-EQ4 configured in order to carry out the proposed estimation method will be described in more detail with reference to FIGS. 4a and 4b. The estimation method will be described in detail with reference to FIGS. 2a and 2b.

Each equipment item EQ1-EQ4 may implement applications as well as application programming interfaces (API) intended to allow the applications to communicate with one another. Thus, applications installed in the same equipment item or applications installed in different equipment items may communicate via application programming interfaces. For example, a mobile terminal of a user may implement a payment application which needs to interact with an application installed in an electronic payment terminal (EPT). These applications exchange data with one another via application programming interfaces installed respectively in the two equipment items.

The time of flight TV between the equipment items may be estimated by carrying out the proposed estimation method. As will be described below, the estimation method is a collaborative estimation method. When a first equipment item EQ1 carries out the method for estimating the time of flight TV between itself and a second equipment item EQ2 (time of flight TV₁₂), the second equipment item participates in the estimation. Furthermore, the first equipment item EQ1 may share the time of flight TV₁₂ between itself and the second equipment item EQ2 with the second equipment item EQ2 and/or with other equipment items D3-D4.

FIG. 2a illustrates steps of the estimation method according to one embodiment in the form of an exchange between a first equipment item EQ1 and a second equipment item EQ2.

In the embodiment illustrated in FIG. 2a, the estimation method is carried out by a first equipment item EQ1 in order to estimate the time of flight between itself and a second equipment item EQ2.

The estimation method may nevertheless be carried out by the first equipment item EQ1, by the second equipment item EQ2 or by both equipment items EQ1, EQ2 (FIG. 2b).

In one embodiment, the estimation method is carried out at the application level, that is to say when implementing at least one application installed in an equipment item. In the embodiment described with reference to FIG. 2a, the estimation method is carried out when implementing at least one application installed in the first equipment item EQ1. For example, this application may require knowledge of the time of flight between the first equipment item EQ1 and the second equipment item EQ2, in order then to deduce the distance separating these equipment items. Of course, it may be carried out during implementation of the applications installed respectively in the first equipment item EQ1 and in the second equipment item EQ2. For example, the estimation method may be carried out by the first equipment item EQ1 when an application executed by the first equipment item EQ1 needs to interact with an application installed in the second equipment item EQ2 and when an operation is conditioned by the distance D separating these equipment items. The time of flight obtained by carrying out the estimation method may be used in order to deduce the distance D separating the two equipment items, this distance being usable by the first equipment item EQ1 when implementing the application.

For example, a bank transaction is carried out when the distance between the user terminal and the electronic payment terminal is less than a predefined distance. Similarly, the interaction of an equipment item with an equipment item giving access to resources, the access to which is controlled, such as an electronic lock, a door or an elevator which are secured by a code, etc., may be conditioned by the distance between the equipment items. It will be noted that checking the distance between the equipment items makes it possible to secure the access to the equipment items and to satisfy the security and/or confidentiality requirements.

The determination of the distance is carried out by using a constant indicative of the propagation speed of the signals. The determination of the distance between two equipment items on the basis of the time of flight between two equipment items is known to the person skilled in the art and will not be described here.

According to one embodiment, the first equipment item EQ1 carries out the transmission E0 of a message M1 including a reception information item DA1 representative of an instant t1 starting from which the first equipment item EQ1 is configured in order to receive messages. This information item DA1 represents a delay for which the first equipment item EQ1 waits after the transmission of the message M1 before starting to listen for messages. This information item DA1 is consequently a waiting delay.

In one embodiment, this message M1 may be broadcast, that is to say transmitted without being intended to be received by one or more recipients in particular. In another embodiment, the message M1 may be intended to be received by one equipment item in particular, for example the second equipment item EQ2, or by a group of equipment items including the second equipment item EQ2.

When the second equipment item EQ2 receives the message M1 from the first equipment item EQ1, it extracts the reception information item DA1 from the first message M1 and determines the instant t_{E} at which it will send a message M2 to the first equipment item EQ1, while taking into account the reception information item DA1. In other words, the second equipment item EQ2 takes account of the received reception information item DA1 in order to determine the instant t_{E} of transmission of a message M2 intended to be received by the second equipment item EQ2, including a transmission information item DAR1.

The message M2 sent by the second equipment item EQ2 to the first equipment item EQ1 includes a transmission information item DAR1 representative of the delay which has elapsed between the reception of the message M1 from the first equipment item and the transmission of the message M2. Thus, the transmission information item DAR1 represents a time interval between the instant t_{R} of reception of the message M1 from the first equipment item EQ1 and the instant t_{E} of transmission by the second equipment item EQ2 of the message M2 including the transmission information item DAR1.

In practice, the instant t_{E} at which the second equipment item transmits the message M2 intended to be received by the first equipment item EQ1 is determined by adding the reception information item DA1 to the instant t_{R} of reception of the message M1 from the first equipment item EQ1. It will be noted that, since the second equipment item EQ2 is aware of the delay DA1 waited by the first equipment item EQ1 before starting to listen for messages, it carries out the transmission of the message intended to be received by the first equipment item EQ1 once this delay has elapsed.

For example, the instant of reception may be represented by a date and a time according to a time system. According to another example, the instant of reception may be an instant determined relative to a reference instant.

The first equipment item EQ1 then receives the transmission information item DAR1 from the second equipment item EQ2 during a reception step E1. By receiving this transmission information item DAR1, the first equipment item EQ1 is aware of the time which the second equipment item EQ2 has actually waited before transmitting the message M2.

Next, by using the transmission information item DAR1, the first equipment item EQ1 carries out the estimation E2 of the time of flight TV (TV₁₂) between the first equipment item EQ1 and the second equipment item EQ2.

It will be noted that, in order to simplify the references to the figures, the time of flight TV₁₂ between the first equipment item and the second equipment item is referred to as TV.

According to one embodiment, the time of flight TV is determined on the basis of the instant t_{E1} of transmission of the first message M1, the instant t_{R2} of reception of the second message and the received transmission information item DAR1.

For example, the time of flight TV or propagation time of the signals carrying the messages M1 and M2 may be determined in the following way:

$$T {V}_{12} = \frac{{t}_{R 1} - {t}_{E 1} - D R A}{2}$$

where t_{R1} corresponds to the instant of reception of the message M2 from the second equipment item EQ2, t_{E1} corresponds to the instant of transmission of the first message M1 and DRA corresponds to the received transmission information item.

Next, if necessary, the physical distance D between two equipment items may be deduced as a function of the estimated propagation time. It is thus possible to determine whether two equipment items are sufficiently close or far apart to carry out an operation required by an application.

In one embodiment, the first equipment item EQ1 carries out transmission E3 of the estimated time of flight TV. For transmission, the time of flight TV is inserted into a message M3.

In one embodiment, in which the distance D is determined for example by requirements of an application, the first equipment item EQ1 may thus insert the distance D, determined as a function of the estimated time of flight TV, into the message M3 (or into another message).

In the embodiment described, the transmission E3 of the time of flight TV by the first equipment item EQ1 is intended to be received by the second equipment item EQ2.

According to some embodiments, the time of flight TV (optionally accompanied by the distance D) may be broadcast, that is to say transmitted without being intended to be received by one equipment item in particular, or may be transmitted in order to be received by one equipment item in particular, for example by the second equipment item EQ2. In the first embodiment, the time of flight TV between the first equipment item EQ1 and the second equipment item EQ2 is received by other equipment items. This embodiment may be useful for supervision applications, for example. In the second embodiment, only the second equipment item EQ2 receives the time of flight TV between the equipment items, estimated by the first equipment item.

It will be noted that the proposed estimation method is a collaborative method, that is to say the second equipment item participates in the estimation of the time of flight TV carried out by the first equipment item EQ1. Furthermore, the second equipment item EQ2 is aware of the time of flight TV estimated by the first equipment item, which may be useful in particular when the second equipment item is not configured in order to carry out the estimation of the time of flight. Furthermore, other equipment items may receive the time of flight TV between the first and second equipment items, estimated by the first equipment item.

According to one embodiment, the instants of transmission and reception of the messages are stored in order to be used during the estimation of the time of flight between the equipment items. These storage steps are not illustrated in the figures.

According to one embodiment, the first equipment item EQ1 stores the estimated time of flight TV between the first equipment item and the second equipment item in its memory. For example, the first equipment item EQ1 may be configured in order to form a table T comprising times of flight, which it has itself estimated, between the first equipment item EQ1 and other equipment items EQ2-EQ4. This table may also comprise times of flight between the first equipment item EQ1 and other equipment items EQ2-EQ4 and/or times of flight between the other equipment items EQ2-EQ4, which it has received from other equipment items EQ2-EQ4.

In one embodiment, the first equipment item EQ1 repeats the transmission of a reception information item DA2 representative of an instant starting from which the first equipment item EQ1 is configured in order to receive messages. As indicated above, this information item DA2 represents a delay for which the first equipment item EQ1 waits after the transmission of a message before starting to listen for messages.

In the embodiment described, the estimated time of flight TV and the reception information item DA2 are transmitted in the same message M3. Thus, the transmitted message M3 includes the time of flight TV and the reception information item DA2. The reception information item DA2 represents a delay for which the first equipment item EQ1 waits after the transmission of the message M3 containing the estimated time of flight TV, before starting to listen for messages.

It will be noted that, when a message carries a reception information item, this reception information item is indicative of the instant starting from which the equipment item transmitting the message is configured in order to receive messages after the transmission of the message. In other words, the reception information item represents a delay for which the transmitting equipment item waits after the transmission of the message, before starting to listen for messages.

According to other embodiments, the estimated time of flight and the reception information item may be transmitted in different messages.

By receiving the message M3, the second equipment item EQ2 receives the reception information item DA2 of the first equipment item in addition to obtaining the time of flight between itself and the first equipment item. As described above, the second equipment item uses the reception information item DA2 in order to determine the transmission information item DAR2, introduces it into a message M4 and transmits this message M4 intended to be received by the first equipment item EQ1. Thus, in this embodiment, the second equipment item repeats the transmission of a message M4 comprising the transmission information item DAR2 intended to be received by the first equipment item EQ1. Upon reception of this message M4 from the second equipment item EQ2, the first equipment item repeats the steps E1 of reception, E2 of estimating the time of flight TV and E3 of transmitting the estimated time of flight TV.

It will be noted that the first equipment item EQ1 thus obtains the time of flight between itself and the second equipment item for a second time.

According to one embodiment, this second estimation of the time of flight may replace the first estimation. For example, the second estimated time of flight may be stored in the time of flight table, in place of the first. This embodiment is useful in particular when the equipment items are mobile, for example in order to estimate the time of flight between the equipment items in real time.

According to another embodiment, the first equipment item may carry out a comparison of the stored estimated times of flight (there being 2 of them in this example) and, if the difference is less than a predefined threshold, the average of the times of flight may be calculated. The average obtained is retained as the estimated time of flight between the two equipment items. This embodiment is favored when the equipment items have a fixed location.

The transmission, reception and estimation steps carried out by the first equipment item may be repeated, for example each time the applications installed in the first equipment item and the second equipment item exchange messages.

It will be noted that the references for a given step are identical and contain an indication of the number of the repetition. For example, E1_1 refers to the reception step E1 carried out by the equipment item for the first time, E1_2 refers to the reception step E1 carried out by the equipment item for the second time, etc. For the sake of clarity, the references in the description do not give an indication of the iteration number. For example, the reception step is referenced by E1.

According to another embodiment, the steps of transmission E0, E3, reception E1 and estimation E2 are repeated by the first equipment item periodically.

By virtue of the repetition of the steps, the value of the estimated time of flight is optimal. It will be noted that the propagation time of the radiofrequency signals is variable depending on the context in which the equipment items are to be found. Thus, the more the steps are repeated, the more the accuracy of the estimated time of flight increases. This is because if the equipment items remain immobile, calculating the average of the estimated times of flight makes it possible to avoid an estimation error affecting applications using the estimated time of flight (for example in order to determine the distance separating the equipment items or in order to synchronize the equipment items).

In addition, repeating the steps makes it possible to take movements of the equipment items into account.

Furthermore, by virtue of the proposed estimation method, by analyzing the values of the estimated times of flight, certain applications may detect that the equipment items have been displaced or that an abnormal situation has occurred, for example that an obstacle has been placed between the equipment items.

In the form of exchange between a first equipment item EQ1 and a second equipment item EQ2, FIG. 2b illustrates steps of the estimation method according to one embodiment, when it is carried out by the first equipment item as well as by the second equipment item. It will be noted that the two equipment items respectively estimate the time of flight between them and share this at least with the other equipment item. In this embodiment, the two equipment items EQ1, EQ2 are configured in order to carry out the proposed estimation method. The results obtained by this embodiment are optimal.

The second equipment item performs the steps carried out by the first equipment item, which are described with reference to FIG. 2a. Thus, the steps in common with FIG. 2a will not be described again in detail.

As in the embodiment described with reference to FIG. 2a, the first equipment item EQ1 transmits a message M1 including a reception information item DA1 representative of an instant starting from which the first equipment item EQ1 is configured in order to receive messages after the transmission of the message M1. The second equipment item EQ2 receives this message and determines (not represented) the instant t_{E} of transmission of a message M2 intended to be received by the first equipment item, while taking into account the reception information item DA1 present in the message M1 which it has received from the first equipment item EQ1.

In practice, the instant t_{E} at which the second equipment item transmits the message M2 intended to be received by the first equipment item EQ1 is determined by adding the reception information item DA1 to the instant t_{R} of reception of the message M1 from the first equipment item EQ1. It will be noted that, since the second equipment item EQ2 is aware of the delay DA1 waited by the first equipment item EQ1 before starting to listen for messages, it carries out the transmission of the message intended to be received by the first equipment item EQ1 once this delay has elapsed.

The second equipment item EQ2 introduces the transmission information item DAR1 relating to the message M2, intended to be received by the first equipment item EQ1, into the message M2.

In this embodiment, the second equipment item EQ2 introduces into the message M2 a reception information item DB1 representative of the instant starting from which the second equipment item EQ2 is configured in order to receive messages, after the transmission of this message M2.

In other embodiments, the reception information item DB1 may be transmitted, in order to be received by the first equipment item EQ1, in a different message. It will be noted that the reception information item introduced into a message represents the instant starting from which the equipment item transmitting the message is configured in order to receive messages after carrying out the transmission.

Thus, in this embodiment, the message M2 sent by the second equipment item EQ2 to the first equipment item EQ1 includes the transmission information item DAR1 representative of the delay which has elapsed between the reception of the message M1 from the first equipment item and the transmission of the message M2, as well as the reception information item DB1 representative of the instant starting from which the second equipment item EQ2 is configured in order to receive messages.

During the reception step E1, the first equipment item EQ1 receives the message M2 from the second equipment item and estimates E3 the time of flight TV between the two equipment items EQ1, EQ2 by using the received transmission information item DAR1.

Furthermore, the first equipment item EQ1 determines (not represented) the instant t_{E} of transmission of the next message M3 intended to be received by the second equipment item, while taking into account the reception information item DB1 present in the message M2 which it has received from the second equipment item EQ2.

In practice, the instant t_{E} at which the first equipment item EQ1 transmits the message M3 intended to be received by the second equipment item EQ2 is determined by adding the reception information item DB1 to the instant t_{R} of reception of the message M2 from the second equipment item EQ2. It will be noted that, since the first equipment item EQ1 is aware of the delay DB1 waited by the second equipment item EQ2 before starting to listen for messages, it carries out the transmission E3 of the message M3 intended to be received by the second equipment item EQ2 once this delay DB1 has elapsed.

Thus, the first equipment item introduces the transmission information item DBR1 into the message M3, this transmission information item DBR1 representing a time interval between the instant t_{R} of reception of the message M2 from the second equipment item EQ2 and the instant t_{E} of transmission of the message M3 including the transmission information item DBR1 by the first equipment item EQ1.

In the embodiment described, the message M3 furthermore includes the time of flight TV12_1 estimated by the first equipment item EQ1, as well as a reception information item DA2 representative of an instant starting from which the first equipment item EQ1 is configured in order to receive messages after the transmission of the message M3.

In one embodiment, the message M3 may furthermore include the distance D12_1 estimated by the first equipment item.

In other embodiments, the estimated time of flight and/or the reception information item are transmitted in different messages.

Upon reception of the message M3, during a reception step E1 (illustrated as E1_1_2 in order to indicate that this is the first transmission carried out by the second equipment item), the second equipment item EQ2 determines the transmission information item DAR2 for the next message intended to be received by the first equipment item, while taking into account the received reception information item DA2. In addition, it estimates E2_1_2 the time of flight between itself and the first equipment item EQ1 by using the transmission information item DBR1. Furthermore, while taking into account the received reception information item DA2, the second equipment item EQ2 determines the transmission information item of a message M4 intended to be received by the first equipment item EQ1. The second equipment item EQ2 introduces the transmission information item DAR2, the estimated time of flight TV and the reception information item DB2 into the message M4 intended to be received by the first equipment item.

The steps of reception E1, estimation E2 and transmission E3 are repeated by the first equipment item EQ1. A message M5 comprising the estimated time of flight TV12 (for a second time, TV12_2), the transmission information item DBR2 relating to this message M5 and the reception information item DA3 is thus transmitted E3_2_1.

As for FIG. 2a, the references for a given step are identical and contain an indication of the number of the repetition. For example, E1_1 refers to the reception step E1 carried out by the equipment item for the first time, E1_2 refers to the reception step E1 carried out by the equipment item for the second time, etc. For example, the reception step is referenced by E1. In addition, the reference contains an indication of the equipment item carrying out the step. For example, the reference E1_1_1 indicates the first reception carried out by the first equipment item, and E1_1_2 indicates the first reception carried out by the second equipment item. For the sake of clarity, the references in the description do not give an indication of the iteration number or of the equipment item carrying out the step.

These steps are then repeated by the equipment items EQ1, EQ2. According to one embodiment, the steps are repeated for a predetermined number of times, or for any exchange between the equipment items, for example when implementing the applications installed respectively in the equipment items EQ1, EQ2.

In one embodiment, the messages M1-M5 exchanged between the first equipment item and the second equipment item are messages transmitted respectively by application programming interfaces. These messages M1-M5 include application data, that is to say data necessary for implementing the applications. It will thus be noted that the estimation method uses these messages exchanged between the equipment items at the application level in order to estimate the time of flight between the equipment items. Thus, the estimation method does not use messages dedicated solely to the estimation of this distance.

According to one embodiment, when an equipment item introduces data relating to carrying out the estimation method into a message in transmission, it also introduces into the message a collaborative estimation information item IdTVC indicating that the message contains data relating to the collaborative distance estimation. This information item may be a sequence of data, for example information bits, representing a predefined value. This predefined value is known to the equipment items EQ1-EQ2, so that when an equipment item identifies such a predefined value in a message, it identifies that a request for collaboration in the estimation of a time of flight has been transmitted by the equipment item having transmitted the message.

Thus, in one embodiment, the messages M1-M5 include the collaborative estimation information item IdTVC in addition to the application data and the data mentioned above with reference to FIGS. 2a and 2b.

In one embodiment, at least one equipment item determines E4 the average of the times of flight estimated by itself or by another equipment item. The average which is determined represents the time of flight between the equipment items. This distance may be transmitted to other equipment items.

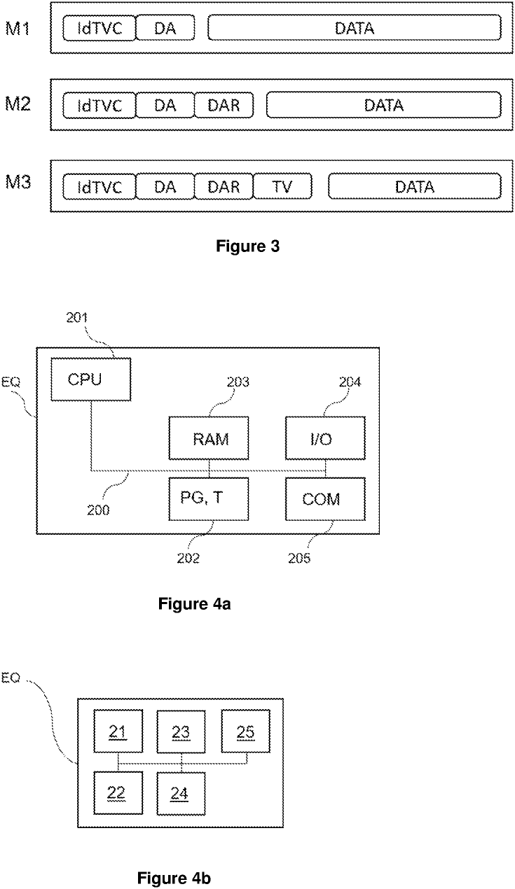

FIG. 3 illustrates examples of messages M1-M3 which may be exchanged between the equipment items EQ1, EQ2.

The first message M1 corresponds to a message initiating the process of collaborative estimation of the time of flight between two equipment items. This message comprises a collaborative estimation information item IdTVC followed by a reception information item DA and application data DATA. This message may correspond to the message M1 transmitted by the first equipment item in the embodiments illustrated in FIGS. 2a and 2b.

The second message M2 corresponds to a message transmitted in response to a message including a reception information item (for example the message M1). It comprises a collaborative estimation information item IdTVC followed by a reception information item DA, a transmission information item DAR and application data DATA. This message may correspond to the message M2 transmitted by the second equipment item in the embodiments illustrated in FIGS. 2a and 2b.

The third message M3 corresponds to a message transmitted by the first equipment item following the estimation of the time of flight, this message including the estimated time of flight. It comprises a collaborative estimation information item IdTVC followed by a reception information item DA, a transmission information item DAR, the estimated time of flight TV and application data DATA. This message may correspond to the message M3 transmitted by the first equipment item in the embodiments illustrated in FIGS. 2a and 2b.

Of course, the order of the information items DA, DAR and TV may be different.

FIG. 4a schematically illustrates a hardware architecture of an equipment item or object which may carry out the proposed estimation method.

The equipment item EQ comprises a communication bus 200, to which the following are connected:
a processing unit 201, which is denoted in the figure as CPU (for Central Processing Unit) and which may include one or more processors;
a nonvolatile memory 202, for example ROM (for Read Only Memory), EEPROM (for Electrically Erasable Read Only Memory) or a flash memory;
a random access memory or RAM 203;
an input/output interface 204, denoted in the figure as I/O, for example keys or buttons, a screen, a keyboard, a mouse or another pointing device such as a touchscreen or a remote control allowing a user to interact with the equipment item EQ via a graphical user interface or man-machine interface; and
a communication interface 205, denoted as COM in the figure, adapted to exchange data for example with other equipment items, or with a server 30 via a communication network.

The random access memory 203 comprises registers adapted for storing variables and parameters created and modified during the execution of a computer program comprising instructions for carrying out the proposed estimation method. The instruction codes of the program stored in the nonvolatile memory 202 are loaded into RAM memory 203 with a view to being executed by the processing unit CPU 201.

The nonvolatile memory 202 is for example a rewritable memory of the EEPROM type or a flash memory, which may constitute a medium in the sense of the invention. That is to say, it may comprise a computer program PG comprising instructions for carrying out the proposed estimation method. The rewritable memory may, for example, comprise a table T listing the time of flight between the equipment item and other equipment items, and/or the times of flight between equipment items other than itself. The instants of transmission, the instants of reception, and the information items received in the messages, such as the transmission information items and/or the reception information items, may be stored in the memory.

By means of its instructions, this program PG defines functional modules of the equipment item EQ, which are implemented and/or control the hardware elements described above. FIG. 4b is a functional representation of an equipment item EQ according to one embodiment.

These modules may, in particular, comprise:
a reception module 21 configured in order to receive from the second equipment item a transmission information item representing a time interval between the instant of reception of a message from said first equipment item and the instant of transmission by said second equipment item of a message including said transmission information item, and
an estimation module 22 configured in order to estimate the time of flight between the first equipment item and the second equipment item by using the transmission information item.

According to some embodiments, the equipment item may furthermore include a transmission module 23 configured in order to transmit the estimated time of flight. This transmission module 23 may furthermore be configured in order to transmit a reception information item representative of an instant starting from which said first equipment item is configured in order to receive messages, the second equipment item taking this reception information item into account in order to determine the instant of transmission of the message including said transmission information item.

According to one embodiment, the transmission module 23 may furthermore be configured in order to transmit a transmission information item representing a time interval between the instant of reception of a message received from the second equipment item and the instant of transmission of a message including said transmission information item.

According to some embodiments, the estimation device may furthermore comprise:
a reception module 24 configured in order to receive the time of flight between the first equipment item and the second equipment item, estimated by the second equipment item,
a determination module 25 configured in order to determine the average of the time of flight previously estimated and the estimated time of flight received from the second equipment item, the average determined being the time of flight.

The aforementioned modules and means are driven by the processor of the processing unit 201. They may take the form of a program executable by a processor or the form of hardware, such as an application-specific integrated circuit (ASIC), a system on chip (SoC), or an electronic component of the programmable logic circuit type, such as a component of the FPGA type (for Field-Programmable Gate Array).

Thus, by virtue of the invention, the time of flight between two equipment items is estimated optimally and collaboratively. The estimated time of flight may be used in order to determine the distance between two equipment items, in order to synchronize two equipment items, in order to detect the movement or the absence of an equipment item, etc.

Although the present disclosure has been described with reference to one or more examples, workers skilled in the art will recognize that changes may be made in form and detail without departing from the scope of the disclosure and/or the appended claims.

1. An estimation method for estimating a time of flight between a first equipment item and a second equipment item, wherein the method is carried out by the first equipment item and comprises:
receiving from the second equipment item a transmission information item representing a time interval between an instant of reception of a message from said first equipment item and an instant of transmission by said second equipment item of a message including said transmission information item, and
estimating the time of flight between the first equipment item and the second equipment item by using the transmission information item.

2. The estimation method according to claim 1, furthermore including transmitting said estimated time of flight.

3. The estimation method according to claim 1, furthermore including transmitting a reception information item representative of an instant starting from which said first equipment item is configured in order to receive messages, the second equipment item taking this reception information item into account in order to determine the instant of transmission of the message including said transmission information item.

4. The estimation method according to claim 2, furthermore including transmitting a transmission information item representing a time interval between an instant of reception of a message received from the second equipment item and an instant of transmission of a message including said transmission information item.

5. The estimation method according to claim 1, furthermore including receiving the time of flight between the first equipment item and the second equipment item, estimated by the second equipment item.

6. The estimation method according to claim 5, furthermore including determining an average of a previously estimated time of flight and the estimated time of flight received from the second equipment item, the average determined being the time of flight.

7. The estimation method according to claim 1, the first and the second equipment item respectively including application programming interfaces, wherein the method if carried out by at least one of the application programming interfaces of the first equipment item.

8. The estimation method according to claim 1, further comprising determining a distance between the first equipment item and the second equipment item using the estimated the time of flight.

9. The estimation method according to claim 1, further comprising synchronizing the first equipment item and the second equipment item using the estimated the time of flight.

10. An estimating device for estimating time of flight between a first equipment item and a second equipment item, the estimation device comprising:
a processor; and
a non-transitory computer readable medium comprising instructions stored thereon which when executed by the processor configure the estimating device to:
receive from the second equipment item a transmission information item representing a time interval between an instant of reception of a message from said first equipment item and an instant of transmission by said second equipment item of a message including said transmission information item, and
estimate the time of flight between the first equipment item and the second equipment item by using the transmission information item.

11. The estimating device of claim 10, wherein the estimating device is implemented by the first equipment item.

12. A non-transitory computer readable information medium on which a computer program comprising instructions is stored, which controls execution of a method of estimating a time of flight between a first equipment item and a second equipment item, when the instructions are executed by a processor of the first equipment item, wherein the method comprises:
receiving from the second equipment item a transmission information item representing a time interval between an instant of reception of a message from said first equipment item and an instant of transmission by said second equipment item of a message including said transmission information item, and
estimating the time of flight between the first equipment item and the second equipment item by using the transmission information item.
